(19) United States
(12) Patent Application Publication
(10) Pub. No.: US 2006/0268243 A1
(43) Pub. Date: Nov. 30, 2006

(54) Projector with improved aperture member

(75) Inventors: Sung-je Woo, Suwon-si (KR); Byung-jo Kang, Suwon-si (KR); Kyung-hwan Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/350,780

(22) Filed: Feb. 10, 2006

(30) Foreign Application Priority Data
May 27, 2005 (KR) 2005-0044872

(51) Int. Cl. G03B 21/14

(52) U.S. Cl. 353/97

(57) ABSTRACT

Provided is a projector that includes a light source, an illumination optical system, an image reproduction unit, an aperture member and a projection unit. The illumination optical system illuminates beams illuminated from the light source. The image reproduction unit modulates the beams illuminated from the illumination optical system into modulated beams used for projecting an image. The aperture member is coupled to the image reproduction unit and has an opening substantially at the center thereof and a light shielding part surrounding the opening. The projection unit projects an image using the modulated beams from the image reproduction unit. The aperture member has one or more connectors the edges of the light shielding part that are insertable into the image reproduction unit. In addition, the aperture member is formed from stainless steal (SUS) or copper (Cu) and is subjected to a black frosting treatment.

### CROSS-REFERENCE TO RELATED APPLICATIONS

This application claims the benefit under 35 U.S.C. §119(a) of Korean Patent Application No. 2005-44872, filed May 27, 2005, in the Korean Intellectual Property Office, the entire disclosure of which is hereby incorporated by reference.

### BACKGROUND OF THE INVENTION

1. Field of the Invention

The present invention relates to a projector. More particularly, the present invention relates to a projector having an improved aperture member for blocking light, in which the aperture member is installed between a light source and an image reproduction unit to block light that is not used for reproducing an image.

2. Description of the Related Art

Optical projectors are classified based on the type of a projection technology employed for reproducing an image on a screen. Types of a projection technology include CRT (Cathode Ray Tube), LCD (Liquid Crystal Display), DLP (Digital Light Processing) and LCoS (Liquid Crystal on Silicon) projection technologies.

The primary component utilized in a CRT projector is a compact high definition CRT. A CRT projector reproduces an image on a screen by using a mirror to reflect image information displayed on the CRT. The primary component utilized in an LCD projector is a compact LCD screen. The typical diameter of a compact LCD screen is four inches. An LCD projector reproduces an image on a screen by using the compact LCD screen to reproduced a received external image signal. Further, the image reproduced by the LCD screen is illuminated by intense light passing through the LCD from the rear of the LCD. The light that is passed is then magnified using a lens and reflected by a mirror.

The primary component utilized in a DLP projector is a DMD (Digital Mirror Device) semiconductor chip integrated with hundreds of thousands of movable micro-mirrors. The DLP projector is operated such that an externally inputted image signal is magnified and projected by the DMD semiconductor chip. The primary component utilized in an LCoS projector is an LCoS semiconductor chip. An LCoS projector reproduces an image on a screen by using liquid crystals applied to a reflective mirror substrate. As the liquid crystals open and close, the light is either reflected from the mirror below, or blocked. This modulates the light and creates the image.

A projector employing any of the above-mentioned types of projection technology usually has an aperture installed on an optical path between a light source and an image reproduction unit to block light that is not used when forming an image.

An example of such a projector is disclosed in Japanese Laid-open Patent Publication Hei 7-281293 (published on Oct. 27, 1995), the entire disclosure of which is hereby incorporated by reference. The projector is configured in such a way that an image is projected from a CRT to a screen via a lens, and a part of the projected light around the image is blocked by a shielding plate.

FIG. 1 shows the construction of a conventional projector, in which an aperture is coated onto a DMD panel.

Referring to FIG. 1, an aperture 1 is black-coated onto a DMD panel 3 which is an image reproduction device. The aperture 1 is coated in substantially a rectangular shape. Therefore, light not used for reproducing an image is blocked by the coated aperture member 1.

However, there is a problem in that since black-coating is a difficult process to perform, the production cost is high, thereby increasing the cost of projectors using a black-coated aperture.

Accordingly, there is a need for a projector having an improved aperture that is not black-coated thereby reducing the manufacturing cost of a projector.

### SUMMARY OF THE INVENTION

Exemplary embodiments of the present invention address at least the above problems and/or disadvantages and provide at least the advantages described below. Accordingly, an aspect of the present invention is to provide a projector, in which an aperture member is configured to be capable of being separately mounted on an image reproduction display, thereby reducing the manufacturing cost of the projector.

In order to achieve the above-mentioned object, according to an aspect of an exemplary embodiment of the present invention, there is provided a projector comprising a light source, an illumination optical system, an image reproduction unit, an aperture member and a projection unit. The illumination optical system illuminates beams illuminated from the light source. The image reproduction unit modulates the beams illuminated from the illumination optical system into modulated beams used for projecting an image. The aperture member is coupled to the image reproduction unit and has an opening substantially at the center thereof and a light shielding part surrounding the opening. The projection unit projects an image using the modulated beams from the image reproduction unit.

According to an exemplary embodiment of the present invention, the aperture member has one or more connectors the edges of the light shielding part that are insertable into the image reproduction unit.

The aperture member is preferably formed from stainless steel (SUS) or copper (Cu) and is subjected to a black frosting treatment.

According to another aspect of an exemplary embodiment of the present invention there is provided a projector comprising a light source, an illumination optical system, a DMD device, an aperture member and a projection unit. The illumination optical system illuminates beams illuminated from the light source. The DMD device receives and modulates the beams illuminated through the illumination optical system, wherein the modulated beams are used for projecting an image. The aperture member is coupled to the image reproduction unit and has an opening substantially at the center thereof and a light shielding part surrounding the opening. The projection unit projects an image using the modulated beams from the DMD device.

The aperture member has one or more connectors the edges of the light shielding part that are insertable into the DMD panel.

The aperture member may be formed from stainless steel (SUS) or copper (Cu) and is subjected to black frosting treatment.

The aperture member comprises red (R), green (G) and blue (B) light emitters for illuminating R, G and B beams, respectively, and the R, G and B light emitters may comprise LEDs (Light Emitted Diodes).

It is preferable that the illumination optical system comprises a dichroic mirror for transmitting a G beam and reflecting R and B beams, a fly eye lens for splitting the beams transmitted through and reflected off the dichroic mirror into unit cells, a reflection mirror for reflecting the beams split through the fly eye lens; and a field lens for converging the beams reflected by the reflection mirror onto the DMD device.

According to the exemplary projector configured as described above, there is an advantage in that as the aperture member is configured as a separate component mounted on the DMD panel, thereby reducing the manufacturing cost of the projector.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a perspective view of a projector according to prior art, in which a DMD coated with an aperture member is shown;

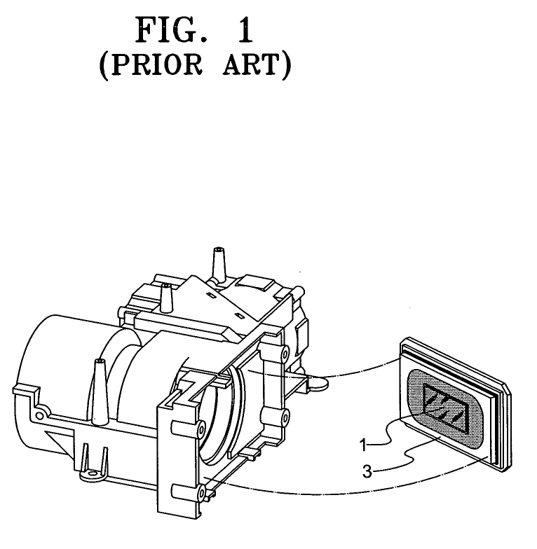

FIG. 2 is a perspective view of a projector according to an exemplary embodiment of the present invention;

FIG. 3 is an exploded perspective view of a projector of an exemplary embodiment of the present invention, in which a DMD panel and an aperture member are disassembled from each other;

FIG. 4 is a perspective view showing an exemplary embodiment of the aperture member assembled with the DMD panel;

FIG. 5 is a cross-sectional view taken along line II-II′ of FIG. 2; and

FIG. 6 is an enlarged view of the part indicated by “V” in FIG. 5.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

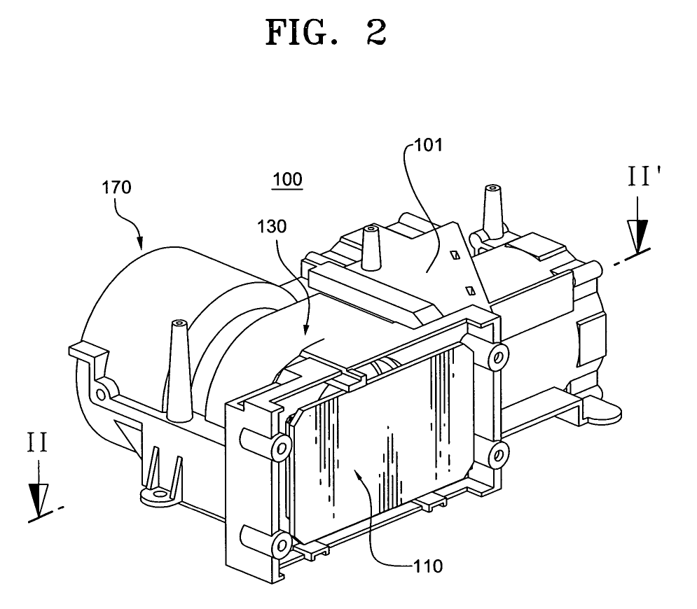

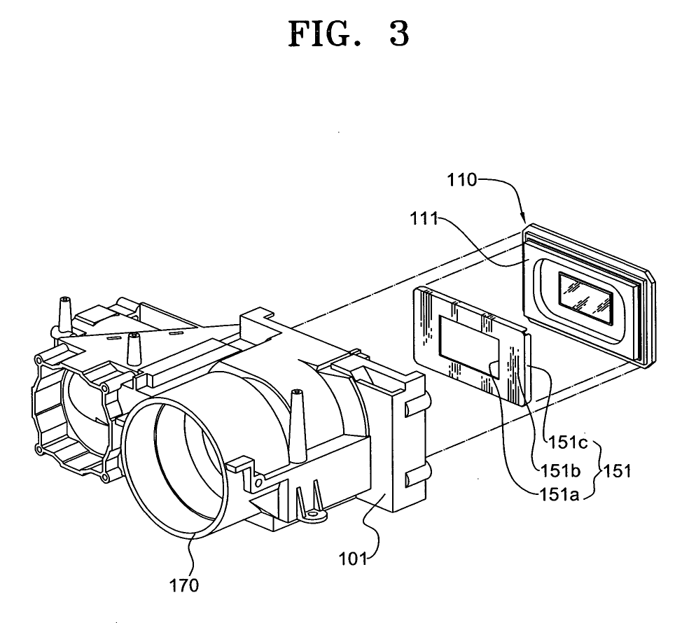

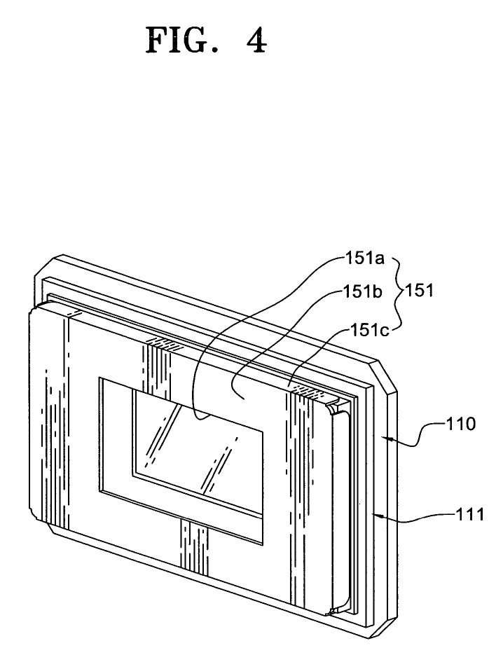

FIG. 2 is a perspective view of a compact projector according to an exemplary embodiment of the present invention. FIG. 3 is an exploded perspective view of the projector of the exemplary embodiment, in which a DMD panel and an aperture member are shown in the disassembled state. FIG. 4 is a perspective view showing the inventive aperture member assembled with the DMD panel.

Referring to FIGS. 2 to 4, the projector 100 includes a projector body 101, a light source 103, an image reproduction unit 110, an illumination optical system 130, a projection unit 170, and an aperture member 151.

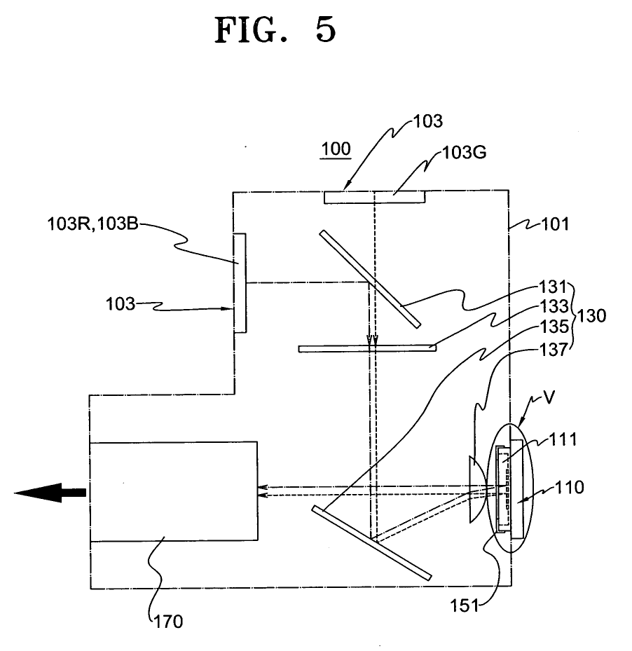

Referring to FIG. 5, the light source 103 includes red (R), green (G) and blue (B) light emitters 103R, 103G and 103B for illuminating R, G and B beams, respectively. The R, G and B light emitters 103R, 103G and 103B may be configured with LED's (Light Emitted Diodes), for example. However, any other type of light emitters may be used as R, G and B light emitters 103R, 103G and 103B.

The image reproduction unit 110 modulates beams illuminated from the light source 103 into beams required for expressing an image and may include, for example, an LCD (Liquid Crystal Display), DMD (Digital Micro-mirror Device), LCoS (Liquid Crystal on Silicon) device or any other type of display device. In the drawings, an exemplary DMD panel 111 is illustrated.

The illumination optical system 130 includes a dichroic mirror 131, a fly eye lens 133, a reflection mirror 135, and a field lens 137.

The dichroic mirror 131 transmits or reflects beams of light depending wavelength of the light; the dichroic mirror 131 is configured to transmit a G beam and to reflect R and B beams.

The fly eye lens 133 splits the beams illuminated from the light source 103 into unit cells and converges the split beams onto a certain area. More specifically, the G beam is transmitted through the dichroic mirror 131 and the R and B beams reflected by the dichroic mirror 131 are split into unit cells.

The reflection mirror 135 reflects the beams split into unit cells through the fly eye lens 133 to the field lens, and the field lens 137 collets the beams reflected by the reflection mirror 135 and passes them to the DMD panel 111.

The projection unit 170 projects the beams modulated by the DMD panel into a form for expression of an image on a screen, wherein the projection unit 170 includes a group of lenses (not shown).

Referring to FIGS. 3, 4 and 6, the aperture member 151 permits only the beams required for expressing an image by the DMD panel 111 and blocks the remaining unnecessary beams. The aperture member 151 takes a rectangular form having an opening 151a at the center thereof and a light shielding part 151b surrounding the opening 151a. The edges of the light shielding part 151 are provided with one or more connectors 151c used for coupling the light shielding part to the DMD panel 111.

The aperture member 151 is formed from stainless steel (SUS), copper (Cu) or any other material and its surface undergoes a black frosting treatment. Therefore, the aperture member 151 is configured to absorb and block beams not used for expressing an image.

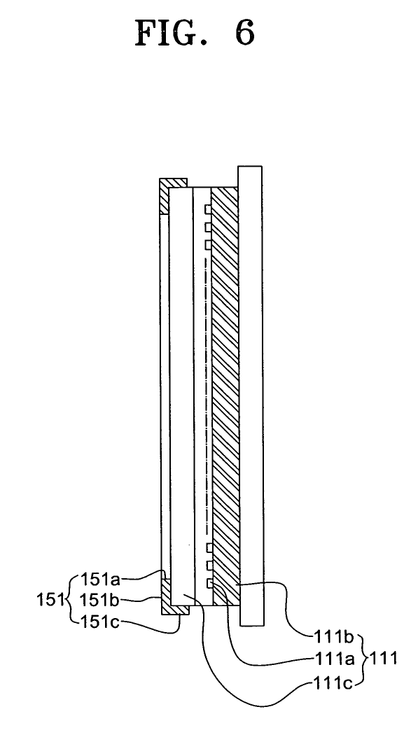

FIG. 6 is an enlarged view of the components referenced by “V” in FIG. 5.

Referring to FIG. 6, the DMD panel 111 includes a ceramic substrate 111b mounted with numerous micro-mirrors 111a, and a protective glass 111c for protecting the micro-mirrors 111a. The aperture member 151 is inserted onto the side of the protective glass opposite the side closest to the micro-mirrors 111a.

Now, the operating principle of the projector configured as described above is described in more detail.

At first, a beam illuminated from any one of the R, G and B light emitters 103R, 103B and 103G of the light source 103 is transmitted through or reflected by the dichroic mirror 131. If the beam is a G beam, it is transmitted through the dichroic mirror 131 and if the beam is an R or B beam, it is reflected by the dichroic mirror 131 in a perpendicular direction.

The beams transmitted through or reflected by the dichroic mirror 131 are split into unit cells through the fly eye lens 133; the split beams are reflected again by the reflection mirror 135 and then converged through the field lens 137, thereby arriving at the DMD panel 111. Thereafter, the beams are converted into beams required for forming an image using the DMD panel and then projected through the projection unit 170.

The beams unnecessary for forming the image are absorbed and blocked by the aperture member 151 attached to the DMD panel.

Although representative embodiments of the present invention have been shown and described in order to exemplify the principle of the present invention, the present invention is not limited to the specific embodiments. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

What is claimed is:

1. A projector comprising:
a light source;
an illumination optical system for illuminating beams illuminated from the light source;
an image reproduction unit for modulating the beams illuminated from the illumination optical system into modulated beams used for projecting an image;
an aperture member coupled to the image reproduction unit having an opening substantially at the center thereof and a light shielding part surrounding the opening; and
a projection unit for projecting an image using the modulated beams from the image reproduction unit.

2. A projector as claimed in claim 1, wherein the aperture member has one or more connectors at edges of the light shielding part, which are adapted to couple the light shielding part to the image reproduction unit.

3. A projector as claimed in claim 2, wherein the connectors at the edges of the light shielding part are insertable into the image reproduction unit.

4. A projector as claimed in claim 1, wherein the aperture member is formed from stainless steal or copper.

5. A projector as claimed in claim 1, wherein the aperture comprises a black coating.

6. A projector as claimed in claim 5, wherein the black coating is applied using a black frosting treatment.

7. A projector as claimed in claim 1, wherein image reproduction unit is one of an LCD (Liquid Crystal Display) and a LCoS (Liquid Crystal on Silicon) device.

8. A projector as claimed in claim 1, wherein the light source comprises red (R), green (G) and blue (B) light emitters for illuminating R, G and B beams, respectively.

9. A projector as claimed in claim 8, wherein the R, G and B light emitters comprise LEDs (Light Emitted Diodes).

10. A projector as claimed in claim 8, wherein the illumination optical system comprises:
a dichroic mirror for transmitting a G beam and reflecting R and B beams;
a fly eye lens for splitting the beams transmitted through and reflected off the dichroic mirror into unit cells;
a reflection mirror for reflecting the beams split through the fly eye lens; and
a field lens for converging the beams reflected by the reflection mirror onto the image reproduction unit.

11. A projector comprising:
a light source;
an illumination optical system for illuminating beams illuminated from the light source;
a digital mirror device (DMD) device for receiving and modulating the beams illuminated through the illumination optical system, wherein the modulated beams are used for projecting an image;
an aperture member coupled to the DMD device and having an opening substantially at the center thereof and a light shielding part surrounding the opening; and
a projection unit for projecting an image using the modulated beams from the DMD device.

12. A projector as claimed in claim 11, wherein the aperture member has one or more connectors at edges of the light shielding part, which are adapted to couple the light shielding part to the image reproduction unit.

13. A projector as claimed in claim 12, wherein the connectors at the edges of the light shielding part are insertable into the DMD device.

14. A projector as claimed in claim 11, wherein the aperture member is formed from stainless steal or copper.

15. A projector as claimed in claim 11, wherein the aperture comprises a black coating.

16. A projector as claimed in claim 15, wherein the black coating is applied using a black frosting treatment.

17. A projector as claimed in claim 11, wherein the light source comprises red (R), green (G) and blue (B) light emitters for illuminating R, G and B beams, respectively.

18. A projector as claimed in claim 17, wherein the R, G and B light emitters comprise LEDs (Light Emitted Diodes).

19. A projector as claimed in claim 17, wherein the illumination optical system comprises:
a dichroic mirror for transmitting a G beam and reflecting R and B beams;
a fly eye lens for splitting the beams transmitted through and reflected off the dichroic mirror into unit cells;
a reflection mirror for reflecting the beams split through the fly eye lens; and
a field lens for converging the beams reflected by the reflection mirror onto the DMD device.
